(19) United States
(12) Patent Application Publication
(10) Pub. No.: US 2007/0141423 A1
(43) Pub. Date: Jun. 21, 2007

(54) TUBULAR ELECTROCHEMICAL REACTOR CELL AND ELECTROCHEMICAL REACTOR SYSTEM WHICH IS COMPOSED OF THE CELL

(75) Inventors: Toshio Suzuki, Aichi (JP); Toshiaki Yamaguchi, Aichi (JP); Yoshinobu Fujishiro, Aichi (JP); Masanobu Awano, Aichi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: National Inst of Adv Industrial Science and Tech., Chiyoda-ku (JP)

(21) Appl. No.: 11/610,258

(22) Filed: Dec. 13, 2006

(30) Foreign Application Priority Data
Dec. 19, 2005 (JP) 2005-364333

(51) Int. Cl. H01M 8/12; H01M 4/90; H01M 4/92; C04B 35/64

(52) U.S. Cl. 429/31; 429/33; 429/40; 264/618

(57) ABSTRACT

The present invention provides a tubular electrochemical reactor cell capable of realizing reduced size and high efficiency, and an electrochemical reactor system using the same, and in a tubular electrochemical reactor cell and an electrochemical reactor system composed thereof, the tubular cell is a tubular cell electrochemical reactor cell in which a dense ionic conductor (electrolyte) and cathode (air electrode) are laminated onto a tube structure composed of an anode (fuel electrode) material, the tube outer diameter being 2 mm or less, the tube wall thickness being 0.5 mm or less, and the porosity of the tube structure being 10% or more; a production process of the tubular electrochemical reactor cell; and, an electrochemical reactor system comprising a chemical reaction unit using the tubular electrochemical reactor cell as a basic unit thereof.

### BACKGROUND OF THE INVENTION

1. Field of the Invention

The present invention relates to a tubular electrochemical reactor cell and an electrochemical reactor system such as a solid oxide fuel cell which is composed of said reactor cell, and more particularly, to a tubular electrochemical reactor cell, which is capable of a high voltage output even using a conventional material by specifying the size of a tubular anode, an electrode structure, and gas flow rate performance in a tubular cell, and to an electrochemical reactor system which utilizes said tubular cell. The present invention provides a novel technology and a novel product relating to an electrochemical reactor cell to be used as a clean energy source and environment purification apparatus, which enables lowering of operating temperature (650° C. or lower) by specifying the size of a tubular cell, electrode structure and so on, and an electrochemical reactor system which uses said reactor cell.

2. Description of the Related Art

A solid oxide fuel cell (abbreviated as SOFC) is a typical example of an electrochemical reactor. An SOFC is a fuel cell that uses a solid oxide electrolyte having ionic conductivity for the electrolyte. The basic structure of this SOFC is normally comprised of three layers consisting of a cathode, a solid oxide electrolyte and an anode, and is normally used in a temperature range of 800 to 1000° C.

When a fuel gas (such as hydrogen, carbon monoxide or hydrocarbon) is supplied to the SOFC anode and air or oxygen is supplied to the cathode, a difference occurs between the oxygen partial pressure at the cathode and the oxygen partial pressure at the anode, thereby resulting in the generation of a voltage between the electrodes according to the Nernst equation. At the cathode, oxygen is ionized after which is moves to the anode by passing through the solid electrolyte, and the oxygen ions that have reached the anode react with the fuel gas and release electrons. Consequently, if a load is connected to the anode and cathode, electrically can be acquired directly from the fuel cell.

Lowering of the operating temperature of SOFC is an important and essential requirement for the future in order to achieve practical application of SOFC. It is critical to reduce the film thickness of the electrolyte in order to lower the operating temperature of SOFC, and extensive research has been conducted in the past on electrode support cells, and particularly anode support cells. Lowering the operating temperature of SOFC to a temperature range of 500 to 600° C. would make it possible to use inexpensive materials and reduce operating costs, and would also contribute to enhanced universality of SOFC. Plate-like SOFC have been reported in the past having a high power output of 0.8 to 1 W/cm² at a low temperature (600° C.) by proposing the use of new anode and cathode materials (Z. Shao and S. M. Haile, Nature, 431, 170-173 (2004); T. Hibino, A. Hashimoto, K. Asano, M. Yano, M. Suzuki and M. Sano, Electrochem, Solid-State Lett, 5(11), A242-A244 (2002)).

However, since anode support SOFC having a high power output reported in the past are characterized by the use of new materials, there are aspects regarding their long-term stability which remain unknown, while also having the problem of the materials being expensive. In addition, plate-like anode support cells have the problem of causing the cell to rupture depending on the operating cycle. This is because, although nickel cermet is typically used, since this undergoes large changes in volume due to the oxidation-reduction atmosphere cycle and temperature changes, the cell becomes distorted, eventually leading to rupture.

Consequently, increasing the size and employing a stacked configuration while maintaining cell performance has been an extremely important technical subject for the plate-like anode support cells described above. Although controlling electrode structure and reducing thickness of the anode support substrate are both important in the case of plate-like cells, it has been difficult to reduce thickness and increase porosity of these plate-like cells for the reasons described above. Research has also been conducted on an SOFC structure composed of a tubular cell as an alternative to plate-like cells (Japanese Patent Application Laid-open No. 2004-335277). However, a small, tubular cell having high efficiency while using conventional materials has yet to be reported.

### SUMMARY OF THE INVENTION

With the foregoing in view, as a result of conducting extensive research for the purpose of developing an SOFC capable of substantially solving the above-mentioned problems of the materials of the prior art while also having high efficiency and high performance using inexpensive conventional materials, and developing new forms of use thereof, the inventors of the present invention found that a highly efficient, high-performance tubular SOFC can be provided by specifying the tube size and electrode structure thereof while retaining porosity required for high efficiency and high performance of a tubular cell, and that an electrochemical reactor system can be provided capable of realizing a lower operating temperature, and along with other new findings, combined these new findings with additional research, thereby leading to completion of the present invention.

An object of the present invention is to provide a tubular electrochemical reactor cell having a cell structure capable of realizing a low operating temperature by adding a specific size and electrode structure to cells using conventional materials. Moreover, another object of the present invention is to provide an electrochemical reactor system such as a solid oxide fuel cell capable of realizing a low operating temperature (650° C. or lower) by using the above-mentioned tubular electrochemical reactor cell.

In order to solve the above-mentioned problems, the present invention is composed of the technical means indicated below.
(1) A tubular electrochemical reactor cell characterized by comprising a tubular cell in which a dense ionic conductor (electrolyte) layer is formed on a tube structure body formed of an anode (fuel electrode) material and a cathode (air electrode) is arranged on the outside of the ionic conductor, wherein an outer diameter of the tube is 2 mm or less, a wall thickness of the tube is 0.5 mm or less, and porosity of the tube structure is 10% or more.
(2) The tubular electrochemical reactor cell according to (1) above, wherein the electrolyte material is an oxide compound containing two or more types of elements selected from the group consisting of Zr, Ce, Mg, Sc, Ti, Al, Y, Ca, Gd, Sm, Ba, La, Sr, Ga, Bi, Nb and W.
(3) The tubular electrochemical reactor cell according to (1) above, wherein the anode (fuel electrode) material composing the tube structure is formed of an element selected from the group consisting of Ni, Cu, Pt, Pd, Au, Ru, Co, La, Sr and Ti, and an oxide compound containing one or more types of these elements.
(4) The tubular electrochemical reactor cell according to (1) above, wherein the anode material is a composite of the anode material defined in (3) above and the electrolyte material defined in (2) above.
(5) The tubular electrochemical reactor cell according to (1) above, wherein the cathode (air electrode) material is composed of an element selected from the group consisting of Ag, La, Sr, Mn, Co, Fe, Sm, Ca, Ba, Ni and Mg, and an oxide compound containing one or more types of these elements.
(6) The tubular electrochemical reactor cell according to (1) above, wherein the cathode material is a transition metal perovskite oxide, or a composite of a transition metal perovskite oxide and a solid electrolyte material.
(7) The tubular electrochemical reactor cell according to (1) above, wherein the thickness of the electrolyte layer is 1 to 100 microns.
(8) An electrochemical reactor system generating an electrical current by an electrochemical reaction, wherein the chemical reaction unit is formed of the tubular cell described in (1) above, and an operating temperature is lowered to 650° C. or lower.
(9) The electrochemical reactor system according to (8) above, containing a stack of the electrochemical reactor cell according to any one of (1) to (7) above as a constituent element thereof.
(10) The electrochemical reactor system according to (9) above, wherein a plurality of the stacks of the electrochemical reactor cell are integrated into a module.
(11) The electrochemical reactor system according to any one of (8) to (10) above, wherein the electrochemical reactor system is a solid oxide fuel cell, exhaust gas-purifying, hydrogen-producing or synthetic gas-producing electrochemical reactor.
(12) A production method of a tubular electrochemical reactor cell characterized by comprising a step of laminating a dense ionic conductor (electrolyte) layer onto a tube structure formed of an anode (fuel electrode) material, sintering them, laminating a cathode (air electrode) onto the outside of the ionic conductor and sintering them to produce a tubular cell.
(13) The production method of a tubular electrochemical reactor cell according to (12) above, wherein the tubular cell is produced by the steps of: mixing an anode material, a cellulose-based polymer and water, and molding the mixture into a tubular molding by extrusion molding followed by drying or calcining; coating a slurry obtained by mixing an electrolyte material, an organic polymer and a solvent onto the resulting tubular molding followed by sintering the anode tube structure and the electrolyte; and coating a cathode material onto the resulting porous tube structure having ionic conductor followed by sintering to produce the tubular cell.
(14) The production method of a tubular electrochemical reactor cell according to (13) above, wherein the organic polymer to be used in the electrolyte slurry is a vinyl polymer.

The following provides a more detailed explanation of the present invention.

A tubular electrochemical reactor cell of the present invention is a tubular cell in which a dense ionic conductor (electrolyte) layer and a cathode (air electrode) are laminated on an anode (fuel electrode) tube structure formed by an organic polymer, and has an electrode structure in which the tube outer diameter is 2 mm or less, the tube wall thickness is 0.5 mm or less, and the porosity of the tube structure is 10% or more.

Since conventional plate-like anode support SOFC having a high power output generated a high output by using novel fuels, there are aspects of the long-term stability thereof which remain unknown, while also having the problem of the materials being expensive. Consequently, the development of a large, stacked structure capable of maintaining the performance of the plate cell is an extremely important technical issue. On the other hand, although SOFC structures composed of a tubular cell have been proposed in the past, a tubular cell has yet to be reported that has both high efficiency and high performance. In contrast, the present invention is able to provide a highly efficient, high-performance tubular SOFC, and an electrochemical reactor system capable of realizing a low operating temperature by using said cell, by specifying the size of the fuel electrode, electrode structure and gas flow rate performance.

Examples of an electrochemical reactor system of the present invention using the above-mentioned electrochemical reactor cell include, but are not limited to, a solid oxide fuel cell (SOFC), exhaust gas-purifying electrochemical reactor and hydrogen-producing reactor. By suitably selecting preferable materials for the anode tube material, electrolyte and cathode material, specifying the electrode structure of the cell, and specifying the fuel gas flow rate performance in the above-mentioned electrochemical reactor cell, an electrochemical reactor system can be constructed demonstrating both high efficiency and high performance even at low temperatures of 650° C. or lower.

In the present invention, from the viewpoint that a material having high ionic conductivity is required for the material of the ionic conductor (electrolyte), an oxide compound containing two or more types of elements selected from the group consisting of Zr, Ce, Mg, Sc, Ti, Al, Y, Ca, Gd, Sm, Ba, La, Sr, Ga, Bi, Nb and W is preferable.

In addition, the material of the anode (fuel electrode) porous tube structure preferably contains a material having high activity with respect to fuel gas, preferable examples of which include materials composed of a composition containing one or more types of elements and/or oxide compounds selected from the group consisting of Ni, Cu, Pt, Pd, Au, Ru, Co, La, Sr and Ti.

Moreover, the material of the cathode (air electrode) is preferably a material having high activity for ionization of oxygen, particularly preferable examples of which include materials composed of one or more types of elements and/or oxide compounds selected from the group consisting of Ag, La, Sr, Mn, Co, Fe, Sm, Ca, Ba, Ni and Mg.

Next, a detailed explanation is provided of a tubular electrochemical reactor as claimed in an embodiment of the present invention, and an electrochemical reactor system comprised thereof. First, an explanation is provided of the composition of the tubular electrochemical reactor cell as claimed in the present invention. FIG. 1 is a schematic drawing of a tubular electrochemical reactor cell as claimed in the present invention. As shown in FIG. 1, a dense electrolyte layer 1 is formed on an anode tube 2 composed of a ceramic hollow tube. A tubular electrochemical reactor cell is then constructed by arranging a cathode 4 on the outside of the electrolyte layer.

An explanation is first provided of the electrolyte layer 1. The thickness of the electrolyte layer 1 is required to be determined in consideration of such factors as the diameter of the porous tube and the specific resistance of the solid electrolyte layer 1 itself. The electrolyte layer 1 is dense and preferably has a thickness within the range of 1 to 100 microns, and more preferably 50 microns or less in order to suppress the electrical resistance of the electrolyte. Here, “dense” refers a substance density of 90% and preferably 95% or more. Since this electrolyte is laminated on the surface of the anode tube, it has the advantage of allowing thickness to be easily reduced and controlled. Normally, under conditions of use as a fuel cell, a fuel gas such as hydrogen, carbon monoxide or methane is supplied to a tube hole 3, while an oxidant gas such as air or oxygen is supplied to the outside thereof.

Here, in a tubular electrochemical reactor cell as claimed in the present invention, it is necessary that the tube thickness be about 0.5 mm or less and the tube diameter be about 2 mm or less. Preferable anode electrode performance can be obtained by making the tube thickness to be 0.5 mm or less. In addition, by making the tube diameter 2 mm or less, a tube structure can be realizing having a highly porous electrode structure while maintaining strength even if the tube thickness is 0.5 mm or less.

In a cell stack, there are no particular limitations on the tube length, and can be arbitrarily determined so as to obtain the required characteristics as an anode while taking into consideration the entire size of the required electrochemical microcoil reactor. In addition, the tube porosity is required to be 10% or more to promote rapid gas diffusion and the reduction reaction.

It is necessary to use a material capable of realizing high ionic conductivity for the electrolyte material, and preferable examples of these materials used include oxide compounds containing two or more types of elements selected from the group consisting of Zr, Ce, Mg, So, Ti, Al, Y, Ca, Gd, Sm, Ba, La, Sr, Ga, Bi, Nb and W.

Particularly preferable examples include stabilized zirconia stabilized with a stabilizer such as yttria (Y₂O₃), calcia (CaO), Scandia (Sc₂O₃), magnesia (MgO), ytterbia (Yb₂O₃) or erbia (Er₂O₃), and ceria (CeO₂) doped with yttria (Y₂O₃), gadolinia (Gd₂O₃) or samaria (Sm₂O₃). Furthermore, the stabilized zirconia is preferably stabilized with one or more types of stabilizers.

More specifically, preferable examples include yttria-stabilized zirconia (YSZ) containing 5 to 10 mol % of yttria as stabilizer, and gadolinia-doped ceria (GDC) containing 5 to 10 mol % of gadolinia as doping agent. In addition, in the case of YSZ, for example, if the yttria content is less than 5 mol %, the oxygen ionic conductivity of the anode decreases, thereby making this undesirable. In addition, if the yttria content exceeds 10 mol %, the oxygen ionic conductivity of the anode similarly decreases, thereby making this also undesirable. This applies similarly to GDC as well.

The tube structure is required to be a composite composed of a mixture of anode material and electrolyte material. The anode material is a metal selected from the group consisting of Ni, Cu, Pt, Pd, Au, Ru, Co, La, Sr and Ti and/or an oxide composed of one or more types of these elements, specific preferable examples of which include nickel (Ni), cobalt (Co) and ruthenium (Ru). Among these, nickel (Ni) can be used preferably since it is comparatively less expensive than other metals and has sufficiently large reactivity with hydrogen and other fuel gases. In addition, a composite composed of a mixture of these elements and oxides can also be used.

Here, in a composite of the anode material and the electrolyte, the mixing ratio of the former and the latter is preferably within the range of 90:10% by weight to 40:60% by weight. This is because a mixing ratio within this range yields superior balance in terms of, for example, conformation between electrode activity and the coefficient of thermal expansion, with a more preferable range being 80:20% by weight to 45:55% by weight. On the other hand, amaterial having high activity for oxygen ionization is preferable for the material of the cathode, and is preferably a material composed of an element selected from the group consisting of Ag, La, Sr, Mn, Co, Fe, Sm, Ca, Ba, Ni and Mg, and one or more types of oxide compounds thereof.

Among these, transition metal perovskite oxides and composites of a transition metal perovskite oxide and an electrolyte material can be used preferably. In the case of using a composite, since oxygen ionic conductivity improves among the required characteristics of the cathode in the form of electron conductivity and oxygen ionic conductivity, oxygen ions formed at the cathode easily migrate to the electrolyte layer, thereby offering the advantage of improved electrode activity of the cathode.

Here, in the case of using a composite of a transition metal perovskite oxide and a solid electrolyte material, the mixing ratio of the former and the latter is preferably within the range of 90:10% by weight to 60:40% by weight. This is because a mixing ratio within this range yields superior balance in terms of, for example, conformation between electrode activity and the coefficient of thermal expansion, with a more preferable range being 90:10% by weight to 70:30% by weight.

Specific preferable examples of transition metal perovskite oxides include compound oxides such as LaSrMnO₃, LaCaMnO₃, LaMgMnO₃, LaSrCoO₃, LaCaCoO₃, LaSrFeO₃, LaSrCoFeO₃, LaSrNiO₃ and SmSrCoO₃.

However, as shown in FIG. 1, an anode exposed portion 5 is formed as a result of a portion of the anode tube on both ends of the porous tube being exposed without being laminated with the electrolyte layer 1. This anode exposed portion 5 functions as an external extraction electrode of the anode. Furthermore, there are no particular limitations on the exposed amount of the anode exposed portion 5, and can be suitably adjusted in consideration of a gas sealing member, electrode collection method or gas outlet flow path and so on.

Next, an explanation is provided of an operating method for operating the tubular electrochemical reactor cell as claimed in the present invention as a single SOFC. As shown in FIG. 2, the anode exposed portions are arranged in a fuel gas feed tube 9, and the anode exposed portions are sealed within the fuel gas feed tube 9 by gas sealing members 8. Although varying according to the operating conditions of the SOFC, specific preferable examples of the primary material composing the fuel gas feed tube include heat-resistant stainless steel and ceramics.

Namely, the anode exposed portions of the tubular electrochemical reactor cell are installed on the inside of the fuel gas feed tube 9, and each electrode connection is sealed by the gas sealing members 8. A suitable material can be used for the material of the gas sealing members 8 provided it is not permeable to gas, and there are no particular limitations thereon. However, it is necessary to conform to the coefficient of the thermal expansion of the anode portion. Specific examples of preferable materials include mica glass, spinel (MgAl₂O₄) and other ceramics.

In addition, collector 11 is attached to the electrode surface (the anode exposed portion 5 and the cathode 4). Specific examples of preferable materials primarily composing the collector 11 include lanthanum chloride (LaCrO₃) and other conductive ceramics, gold, silver, platinum and other precious metal meshes, and stainless steel, nickel mesh and nickel felt.

In addition, electrical power can be generated if the fuel gas is fed to the anode portion and an oxidant gas is fed from a coil hole using an oxidant gas or fuel gas feed unit (such as an external manifold), and a load 12 is connected via a current collection wire 10 between a tube connection and the collector 11. Here, the flow rate of fuel gas in the tubular electrochemical reactor cell must be determined from the viewpoint of fuel efficiency.

Furthermore, although the above provided an explanation of an operating method for operating the tubular electrochemical reactor cell as claimed in the present invention as a single SOFC, this operating method is not limited thereto. In addition, in the present invention, a collection of the tubular electrochemical reactor cells in parallel is referred to as a unit, and this can be suitably formed into a plurality of stacks to compose an electrical power generation apparatus.

Next, an explanation is provided of the action of the tubular electrochemical reactor cell as claimed in the present invention. The tubular electrochemical reactor cell as claimed in the present invention has a specific cell size and electrode structure in which a dense ionic conductor (electrolyte) layer is laminated on a hollow tubular anode structure composed of an anode (fuel electrode) material, the cathode (air electrode) has a tubular cell composition formed on the outside of the electrolyte layer, the outer diameter of the tube thereof is 2 mm or less, the tube wall thickness is 0.5 mm or less, and the porosity of the tube structure is 10% or less.

In the past, it was extremely difficult to realize a high-performance cell having a tube diameter of 2 mm or less while retaining the strength thereof. However, according to the composition of the tubular electrochemical reactor cell described above, a preferable porous tube is obtained that promotes diffusion of fuel gas, and a high-performance tubular SOFC is obtained by specifying the flow rate performance of the fuel gas. In addition, by forming the tubular SOFC into a stack, an electrochemical reactor system can be constructed having enhanced output power per unit volume.

Next, an explanation is provided of a preferable production process of the tubular electrochemical reactor cell as claimed in the present invention. In this method of the present invention, as shown in FIG. 3, an anode material precursor 14 is molded into a tubular shape, laminated with an electrolyte slurry 15, baked, and a cathode slurry 16 is laminated on the outside thereof followed by baking to produce a tubular cell. The production process of a tubular electrochemical reactor cell as claimed in the present invention basically contains the steps described below:
(1) a step in which an anode material, a cellulose polymer and water are mixed followed by molding into a tubular molding by extrusion molding, drying and calcining;
(2) a step in which a slurry comprising a mixture of an electrolyte material, an organic polymer and a solvent is coated onto the resulting tubular molding, and the anode tube structure and electrolyte are simultaneously sintered at 1300 to 1600° C.; and,
(3) a step in which a cathode material is coated onto the resulting porous tube structure with ionic conductor (electrolyte) followed by sintering at 800 to 1300° C.

The following provides a detailed explanation of each step. First, the anode tube is produced using a mixture of an anode material and an electrolyte material. More specifically, a binder is added to a powder of an oxide compound containing two or more types of elements selected from the group consisting of Zr, Ce, Mg, Sc, Ti, Al, Y, Ca, Gd, Sm, Ba, La, Sr, Ga, Bi, Nb and W, and a powder of a metal element or oxide selected from Ni, Cu, Pt, Pd, Au, Ru, Co, La, Sr and Ti and kneaded with water followed by molding the resulting plastic mixture into a tubular molding having a predetermined tube diameter, tube length and tube thickness using an extrusion molding method and so on.

Here, it is necessary to use a cellulose-based organic polymer. It is preferable to use 5 to 50 g, and preferably 10 to 30 g, of the cellulose-based organic polymer to 100 g of the anode material for the amount of binder added. Furthermore, a pore forming agent such as carbon powder can be suitably added as necessary. Although the resulting tube is dried at normal temperatures, it can also be suitably calcined up to a temperature of 100° C. as necessary. As a result, an anode tube can be obtained having a porosity of 10% or more after sintering. Next, a slurry containing an electrolyte material powder is adhered to the resulting tubular molding and dried. The electrolyte slurry is produced by, for example, mixing the electrolyte material powder, an organic polymer and a solvent.

The organic polymer used here is preferably a vinyl polymer. A dispersant and so on can also be suitably added as necessary. The coating thickness can be controlled by controlling the slurry concentration using a solvent in the form of an organic compound such as an alcohol, acetone or toluene. According to this technique, an electrolyte layer forming layer serving as a solid electrolyte layer can be adhered by subsequent sintering to the surface of the tube. There are no particular limitations on the drying method described above, and suitable methods and means can be used.

A preferable example of a method for adhering the above-mentioned slurry is a dip coating method in which the openings on both ends of the anode tube are sealed with a resin-based adhesive and so on, followed by immersing the tube in a slurry containing a solid electrolyte. Furthermore, various other adhesion methods can be used in addition to dip coating, examples of which include brush coating and spraying.

At this time, it is necessary to form an exposed portion, in which the anode portion is exposed without the slurry containing the solid electrolyte adhered thereto, on one end of the outer surface of the resulting tube with electrolyte layer. A structure with electrolyte layer can be obtained by sintering at a predetermined temperature. Although the sintering temperature of this structure is preferably about 1200 to 160° C., there are no particular limitations thereon, and sintering can be suitably carried out at a temperature at which the electrolyte layer becomes dense in consideration of the tube material, porosity and so on. There are no particular limitations on the tube length, and can be suitably determined corresponding to the shape of the stack.

Next, the cathode material is coated onto the electrolyte layer. Particularly preferable examples of the cathode material include materials composed of one or more types of elements selected from the group consisting of Ag, La, Sr, Mn, Co, Fe, Sm and Ca, and an oxide compound thereof. A slurry is then produced from this powder, and the cathode can be formed on the electrolyte layer using a method similar to that used to prepare the above-mentioned solid electrolyte.

Next, the resulting tube is sintered at a predetermined temperature to obtain a tubular electrochemical reactor cell. The sintering temperature is preferably about 800 to 1200° C., there are no particular limitations thereon, and it can be adjusted to various temperatures in consideration of the type of the cathode material and so on.

As has been described above, the tubular electrochemical reactor cell can be obtained in which, after having formed the anode tube with electrolyte in which the solid electrolyte layer 1 is adhered to the outer surface of the anode tube 2, the cathode 4 is laminated onto the outside of the electrolyte layer.

Furthermore, the cathode or anode portion of the resulting tubular electrochemical reactor cell can be suitably aligned or the dimensions thereof adjusted as necessary. In addition, although the explanation of the above-mentioned production process described the case of producing a porous tube with electrolyte in advance by sintering a tube coated with an electrolyte slurry followed by laminating a cathode thereon, in addition to this, the electrolyte slurry can be suitably coated after having produced the anode tube.

In the case of laminating these tubular electrochemical reactor cells in the form of a stack, as shown in FIG. 2, the tubes can be arranged in parallel, and a manifold for feeding a fuel gas and collecting current shared by each structure can be used. Moreover, by laminating the same and connecting the manifold on the anode side to the cathode collector one level above by means of an interconnect and so on, the tubular electrochemical reactor cell can be used as an electrochemical reactor cell capable of generating multiple voltages.

In addition, in the tubular electrochemical reactor cell, since tubes to which electrolyte layers are joined can be integrally joined by the cathode material in the case of composing a stack, even if the outside of a tube, for which connection was previously difficult, is in an oxidizing atmosphere, the tubes can be easily electrically connected without using expensive wire made of precious metal and so on.

The present invention exhibits the advantages and effects indicated below.
(1) A tubular electrochemical reactor cell having an electrode structure necessary for realizing high efficiency and high performance can be provided by specifying the tube size and electrode structure, and a ceramic reactor can be provided having a high power output in a low temperature range of 650° C. or lower even if conventional materials are used.
(2) A solid oxide fuel cell or other electrochemical reactor system can be provided capable of operating in a low temperature range of 650° C. or lower using the above-mentioned tubular electrochemical ceramic reactor cell.
(3) The electrochemical reactor system of the present invention can be suitably used, for example, as a clean energy source or environment purification apparatus.
(4) Surface area per unit volume can be increased considerably by reducing the thickness of the electrolyte and decreasing the tube size, thereby making it possible to easily realize low-temperature operation which was difficult with conventional materials.
(5) A stable structure can be maintained even for an anode structure having porosity of 10% or more by making the diameter of the tube composing the fuel electrode 2 mm or less and the tube wall thickness 0.5 mm or less, thereby making it possible to provide a solid oxide fuel cell or other electrochemical reactor system capable of highly efficient, high-performance operation even in a low temperature range of 650° C. or lower.

### BRIEF DESCRIPTION OF THE DRAWINGS

FIG. 1 is a schematic drawing of a tubular electrochemical reactor cell of the present invention;

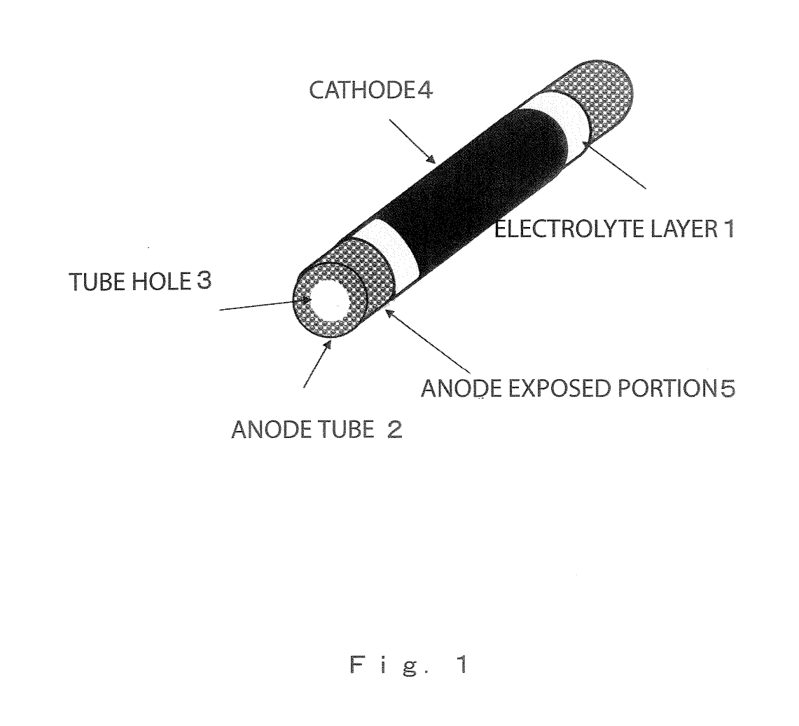

FIG. 2 shows an example of the constitution in the case of using a tubular electrochemical reactor cell of the present invention in the form of an SOFC stack;

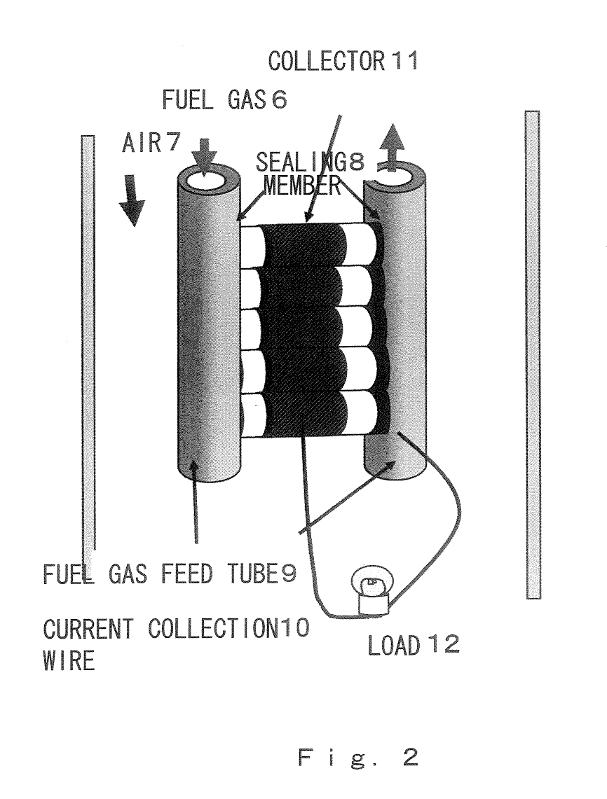

FIG. 3 shows an example of a method for producing a tubular electrochemical reactor cell;

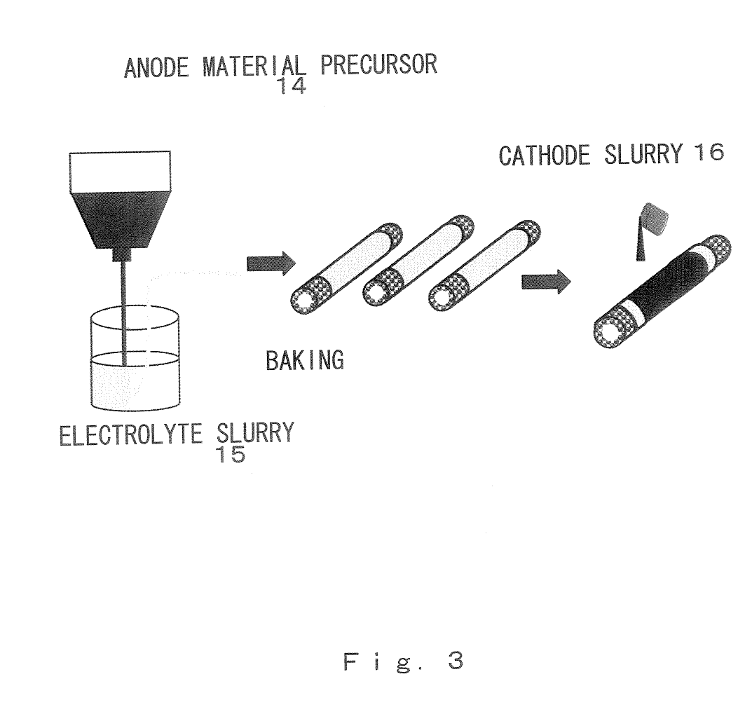

FIG. 4 is an SEM micrograph of a tubular electrochemical reactor cell produced in Example 1;

FIG. 5 shows the relationship between the electrical resistance and tube thickness of an anode tube in a reducing atmosphere;

FIG. 6 is a schematic drawing of the experiment system used in Example 3;

FIG. 7 shows the relationship between initial cell starting time and open circuit voltage at a reactor temperature of 450° C.;

FIG. 8 shows test results of evaluating V-I characteristics of a tubular electrochemical reactor cell at reactor temperatures of 450, 500 and 550° C.; and

FIG. 9 shows test results of evaluating the dependency of output power on anode gas back pressure of a single tubular electrochemical reactor cell (1 cm) at a reactor temperature of 500° C.

### DESCRIPTION OF THE PREFERRED EMBODIMENTS

Although the following provides a detailed explanation of the present invention based on examples thereof, the present invention is not limited in any way by the following examples.

### EXAMPLE 1

In the present invention, a tubular electrochemical reactor cell was produced according to the procedure described below. First, a binder in the form of nitrocellulose was added to NiO (Wako) and a powder having the composition of and CeO₂-10 mol % Gd₂O₃ (GDC) (Anan Kasei) followed by kneading with water to form a clay-like material, and molding into a tubular molding by extrusion molding. The diameter and thickness of the resulting tubular molding were 2 mm and 0.5 mm, respectively (tube outer diameter: 2 mm, tube inner diameter: 1 mm).

Next, after sealing the opening in one end of the resulting tubular molding with vinyl acetate, the tube was immersed in a slurry containing a solid electrolyte composed of GDC to dip coat the tube with an electrolyte layer forming layer and obtain a tubular molding with electrolyte. At this time, the other end of the porous anode tube was left exposed over a distance of 5 mm to form an exposed portion.

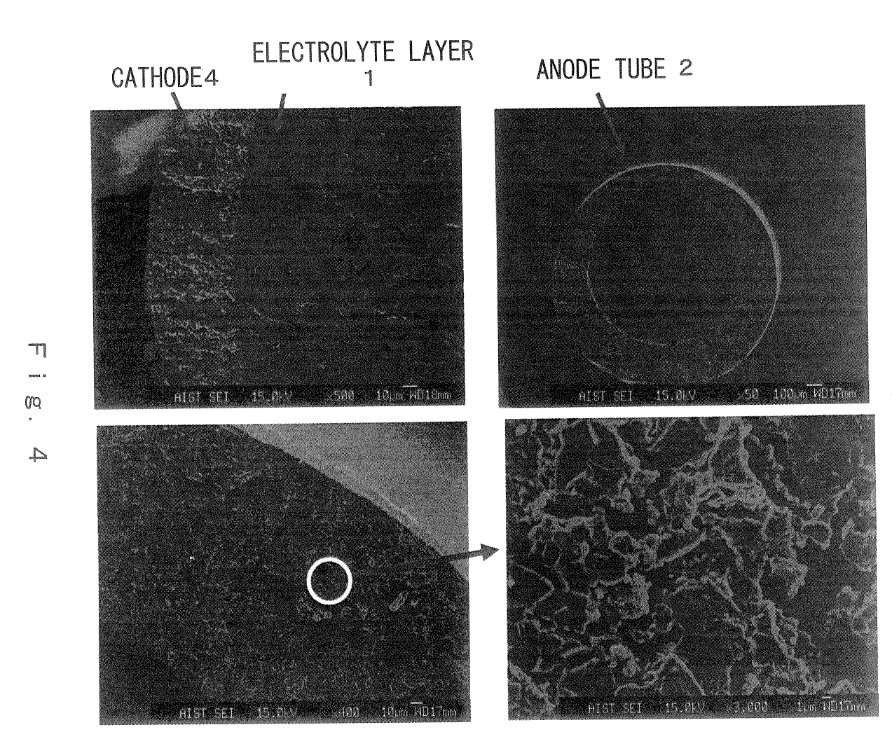

Next, this tubular molding was dried and then sintered for 6 hours at 1450° C. to obtain an anode tube coil with electrolyte. Next, a paste containing a cathode material in the form of LaSrCoFeO₃ (Nippon Ceramic) and an electrolyte material in the form of GDC applied to the electrolyte layer surface within a container, followed by drying at 100° C. and sintering for 1 hour at 1000° C. As a result, a tubular electrochemical reactor cell was obtained. FIG. 4 shows a scanning electron micrograph. As can be understood from FIG. 4, the anode tube has a preferable porous structure. In addition, the tube diameter at completion of the cell was 1.6 mm and the tube thickness was 0.4 mm.

### EXAMPLE 2

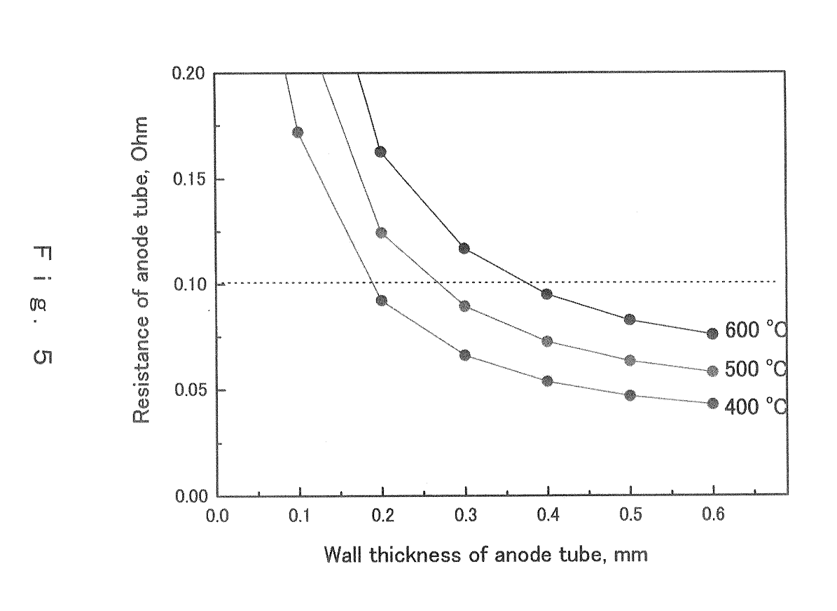

The anode tube obtained in Example 1 was sintered for 6 hours at 1450° C. without coating with electrolyte followed by measurement of electrical resistance in a reducing atmosphere using the direct current 4-pin method. The optimum size of the anode tube was able to be determined using these measurement results. The relationship between electrical resistance and tube thickness of a 1 cm anode tube in a reducing environment is shown in FIG. 5. Adequate resistance values which do not present a problem in current collection at the anode (0.1 Ω or less) were demonstrated in the vicinity of a tube thickness of 0.4 mm for a 1.6 mm diameter tube. On the other hand, since resistance values increase when tube thickness decreases, it is also necessary to determine tube thickness in consideration of the operating temperature. As shown in the drawing, a tube thickness of 0.4 mm is preferable when operating at 600° C., and performance was demonstrated to be able to be expected to be further improved by reducing anode tube thickness at low temperatures without impairing current collection efficiency.

### EXAMPLE 3

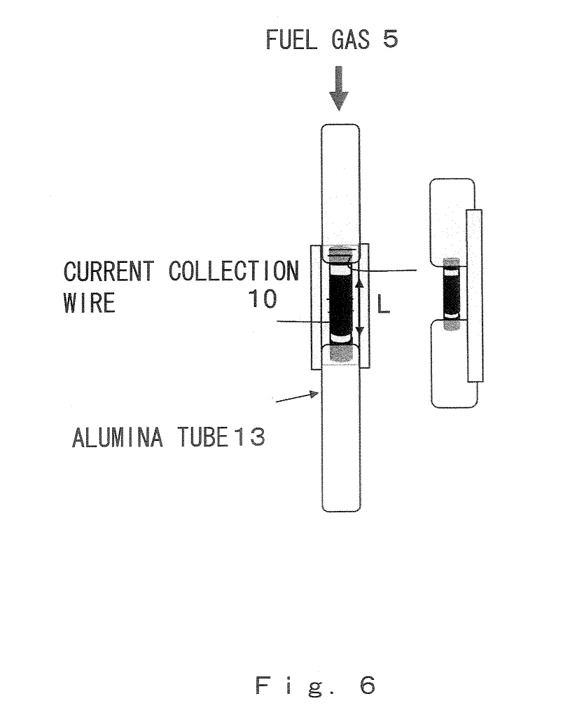

The tubular electrochemical reactor cell obtained in Example 1 was arranged in a sample holder as shown in FIG. 6. L indicates the length of the cathode, and is the effective length of the cell. Current collection at the anode was achieved with a Pt current collection wire 10 from the anode exposed portion, and on the cathode side, the Pt current collection wire 10 was wound around the cathode and fixed with silver paste. Here, the tube diameter was made to be 1.6 mm. In this test, a fuel gas in the form of a fuel gas 5, consisting of a mixture of 5 cc/min of hydrogen saturated with steam at room temperature and 20 cc/min of nitrogen, was fed to an alumina tube 13, while the air electrode side was left open.

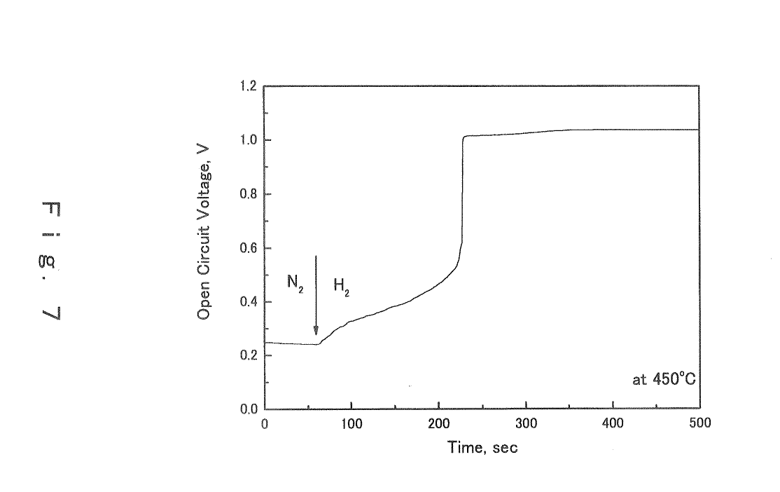

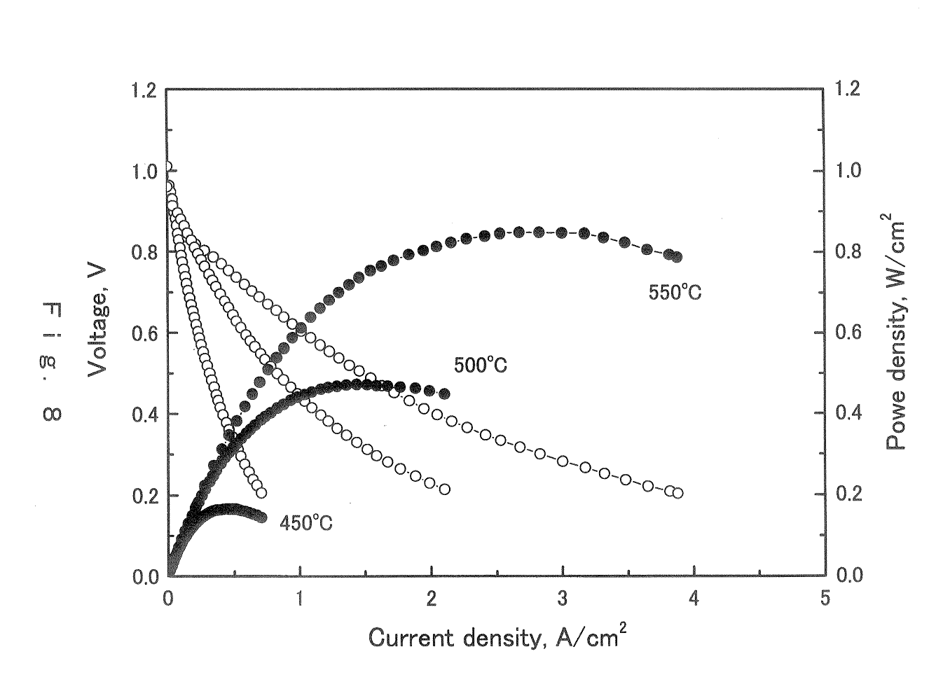

First, in order to evaluate cell starting characteristics, the cell was initially started at 450° C. followed by measurement of open circuit voltage. As shown in FIG. 7, the anode was reduced in a short period of time of about 2 minutes, and power generation performance of 1 V or more was demonstrated despite the ceria-based material. In addition, evaluation of voltage-current characteristics was carried out at reactor temperatures of 450, 500 and 550° C., and V-I characteristics evaluation tests were carried out at each temperature. The results for V-I characteristics are shown in FIG. 8.

As shown in FIG. 8, the results yielded a value in excess of 0.8 W/cm² at 550° C. This surpasses the previously highest level recorded in the world of 0.5 W/cm² for the same material, thereby demonstrating the high performance of the tubular electrochemical reactor cell of the present invention. In addition, this result is comparable to performance achieved with new materials, thus suggesting the possibility of further improvement in performance by changing the materials.

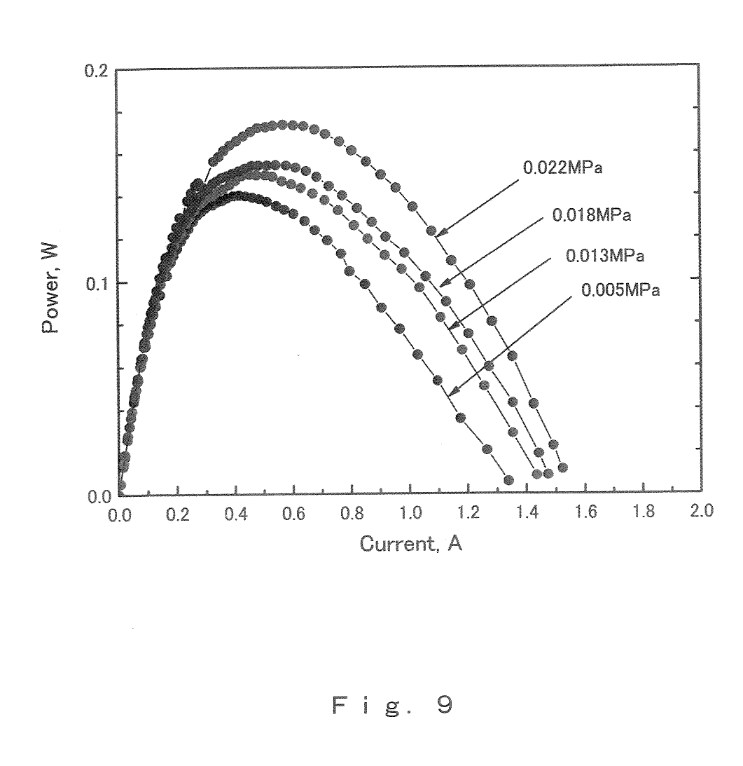

FIG. 9 shows the dependency of output power on anode gas back pressure of a tubular electrochemical reactor cell (1 cm) at a reactor temperature of 500° C. The status of the gas on the cathode side was not changed at this time. As can be understood from FIG. 9, electrical power performance is greatly dependent on anode gas back pressure, and the high level of performance demonstrated by the tubular cell is shown to have been achieved due to the anode tube defined by the present invention. In addition, this result also indicates that performance can be further improved by controlling the gas back pressure.

Although the above has provided a detailed explanation of the present invention based on examples thereof, the present invention is not limited in any way by these examples, and various modifications can be made without deviating from the gist of the present invention. For example, although only a single tubular cell was indicated in the above-mentioned examples, a stacked structure employing said single tubular cells was also confirmed to be able to be produced using a similar procedure.

As has been described in detail above, the present invention relates to a tubular electrochemical reactor cell and an electrochemical reactor system composed thereof. According to the tubular electrochemical reactor cell of the present invention, a highly efficient, high-performance SOFC is obtained by specifying the cell size of the tubular cell, the electrode structure and so on. In addition, in the constitution described above, the operating temperature can be lowered to 650° C. or lower even if conventional materials are used, thereby making it possible to produce and provide an electrochemical reactor having superior cost performance as well as a solid oxide fuel cell or other electrochemical reactor system using said reactor. The present invention is useful for providing new technologies and new products relating to a new type of electrochemical reactor using a tubular cell and a solid oxide fuel cell or other electrochemical reactor system using said electrochemical reactor.

What is claimed is:

1. A tubular electrochemical reactor cell characterized by comprising a tubular cell in which a dense ionic conductor (electrolyte) layer is formed on a tube structure body formed of an anode (fuel electrode) material and a cathode (air electrode) is arranged on the outside of the ionic conductor, wherein an outer diameter of the tube is 2 mm or less, a wall thickness of the tube is 0.5 mm or less, and porosity of the tube structure is 10% or more.

2. The tubular electrochemical reactor cell according to claim 1, wherein the electrolyte material is an oxide compound containing two or more types of elements selected from the group consisting of Zr, Ce, Mg, So, Ti, Al, Y, Ca, Gd, Sm, Ba, La, Sr, Ga, Bi, Nb and W.

3. The tubular electrochemical reactor cell according to claim 1, wherein the anode (fuel electrode) material composing the tube structure is formed of an element selected from the group consisting of Ni, Cu, Pt, Pd, Au, Ru, Co, La, Sr and Ti, and an oxide compound containing one or more types of these elements.

4. The tubular electrochemical reactor cell according to claim 1, wherein the anode material is a composite of the anode material defined in claim 3 and the electrolyte material defined in claim 2.

5. The tubular electrochemical reactor cell according to claim 1, wherein the cathode (air electrode) material is composed of an element selected from the group consisting of Ag, La, Sr, Mn, Co, Fe, Sm, Ca, Ba, Ni and Mg, and an oxide compound containing one or more types of these elements.

6. The tubular electrochemical reactor cell according to claim 1, wherein the cathode material is a transition metal perovskite oxide, or a composite of a transition metal perovskite oxide and a solid electrolyte material.

7. The tubular electrochemical reactor cell according to claim 1, wherein the thickness of the electrolyte layer is 1 to 100 microns.

8. An electrochemical reactor system generating an electrical current by an electrochemical reaction, wherein the chemical reaction unit is formed of the tubular cell described in claim 1, and an operating temperature is lowered to 650° C. or lower.

9. The electrochemical reactor system according to claim 8, containing a stack of the electrochemical reactor cell according to any one of claims 1 to 7 as a constituent element thereof.

10. The electrochemical reactor system according to claim 9, wherein a plurality of the stacks of the electrochemical reactor cell are integrated into a module.

11. The electrochemical reactor system according to any one of claims 8 to 10, wherein the electrochemical reactor system is a solid oxide fuel cell, exhaust gas-purifying, hydrogen-producing or synthetic gas-producing electrochemical reactor.

12. A production method of a tubular electrochemical reactor cell characterized by comprising a step of laminating a dense ionic conductor (electrolyte) layer onto a tube structure formed of an anode (fuel electrode) material, sintering them, laminating a cathode (air electrode) onto the outside of the ionic conductor and sintering them to produce a tubular cell.

13. The production method of a tubular electrochemical reactor cell according to claim 12, wherein the tubular cell is produced by the steps of: mixing an anode material, a cellulose-based polymer and water, and molding the mixture into a tubular molding by extrusion molding followed by drying or calcining; coating a slurry obtained by mixing an electrolyte material, an organic polymer and a solvent onto the resulting tubular molding followed by sintering the anode tube structure and the electrolyte; and coating a cathode material onto the resulting porous tube structure having ionic conductor followed by sintering to produce the tubular cell.

14. The production method of a tubular electrochemical reactor cell according to claim 13, wherein the organic polymer to be used in the electrolyte slurry is a vinyl polymer.
